(19) United States
(12) Patent Application Publication
(10) Pub. No.: US 2011/0054117 A1
(43) Pub. Date: Mar. 3, 2011

(54) Polyolefin Adhesive Compositions and Method of Making Thereof

(76) Inventor: Gregory K. Hall, Humble, TX (US)

(21) Appl. No.: 12/832,213

(22) Filed: Jul. 8, 2010

Related U.S. Application Data
(60) Provisional application No. 61/237,399, filed on Aug. 27, 2009.

(51) Int. Cl. C08L 23/14

(52) U.S. Cl. 524/579

(57) ABSTRACT

Adhesive compositions comprising a polypropylene copolymer containing at least 85 mole % propylene and at least than 15 mole % co-monomer. The adhesive composition has a variety of end uses specifically in elastic attachment applications for nonwoven disposable articles.

### CROSS REFERENCE TO RELATED APPLICATIONS

This application claims the benefit of prior U.S. provisional application Ser. No. 61/237,399 filed Aug. 27, 2009 which is hereby incorporated by reference in its entirety.

### BACKGROUND

This invention relates to polyolefin adhesive compositions, a method of making thereof and articles made therefrom.

Hot melt adhesives (HMAs) have become part of everyday life. With the development of high speed manufacturing and processing equipment, hot melt adhesives can be found in many applications. These range from furniture and shoe manufacture, to packaging applications, to the production of baby diapers.

A HMA is a thermoplastic material, which is solid at room temperature, and which is applied in its molten form to a substrate and which will adhere to the surface of the substrate when cooled to a temperature below its melting point.

The typical HMA is used and classified as a constructive adhesive that can be used in packaging or furniture applications, but specialty HMAs such as elastic attachment HMA can be used in diaper and incontinent product applications to bond the elasticized areas. It is known that most construction adhesives are not suitable for bonding of the elastic because the creep resistance is insufficient for bonding the elasticized areas. Accordingly, there exists a current and long felt need for adhesive compositions that overcome known deficiencies in conventional compositions and that have advantageous processing properties.

### SUMMARY

There is provided an adhesive composition and a method for making an adhesive composition as defined in any one of the accompanying claims.

In an embodiment, there is provided an adhesive composition comprising a polyolefin copolymer comprising at least 85 mole % of units derived from propylene and from about 1 to about 15 mole % of units derived from at least one C4 to C10 alpha-olefin, wherein the copolymer has a molecular weight of less than 60,000 and a heat of fusion between about 5 and about 60 J/g, a weight-average molecular weight/number-average molecular weight ratio (Mw/Mn) from about 1.8 to 10.

### DESCRIPTION OF THE PREFERRED EMBODIMENTS

In HMAs, limitations in creep retention can hinder the performance of the adhesive in an elastic attachment application. For example, if the creep retention is too low, the adhesive seal can be undone during the use of the product. This is highly undesirable.

To control the retention time adhesive, a low molecular weight, low crystallinity propylene copolymer has been developed that has the requisite creep retention performance needed to be used in elastic applications such as diaper elastic attachment.

Disclosed herein is a copolymer of propylene comprising at least 50 mole % of a polypropylene polymer having a weight average molecular weight of less than 60,000 and a heat of fusion between about 5 and about 60 J/g. When used as an adhesive, the present copolymer exhibits a novel and advantageous combination of properties including a creep retention of greater than 80%.

Preferably, the copolymer comprises about 1 mole % to about 15 mole %, about 1 mole % to about 10 mole %, about 4 to about 8 mole %, or about 5 mole % to about 7 mole % of units derived from said at least one C4 to C10 alpha-olefin. Preferably, said copolymer has a weight-average molecular weight of less than 80,000, such as less than 60,000. For example, said copolymer may have a weight-average molecular weight of from 10,000 to 250,000, from 10,000 to 100,000, from 10,000 to 80,000; from 20,000 to 70,000; from 30,000 to 65,000; from 35,000 to 60,000; from 40,000 to 55,000; or from 40,000 to 50,000.

Various components of the adhesive composition of the invention are disclosed in detail below.

### Copolymer

The adhesive compositions of the invention are composed of polyolefin polymer compositions, which include propylene polymers. Propylene-based polymers are polymers comprised of a majority of propylene monomers on a molar basis. As used herein, “polypropylene”, “polypropylene polymer(s)”, or “propylene polymer(s)” mean (i) homopolymers, copolymers, terpolymers, higher order copolymers, or interpolymers comprised of a majority of propylene monomers on a molar basis or (ii) combinations thereof.

As used herein, the term “homopolymer” means polymers resulting from the polymerization of a single monomer, i.e., a polymer consisting essentially of a single type of repeating unit. As used herein, the term “copolymer(s)” refers to polymers formed by the polymerization of at least two different monomers. For example, the term “copolymer” includes the copolymerization reaction product of propylene and an alpha-olefin, such as for example, 1-hexene and also terpolymers.

In another embodiment of the invention, the polyolefin may comprise a propylene-based polymer backbone. The propylene-based polymer backbone preferably comprises propylene, one or more C2 or C4-C20 α-olefins, and optionally a non-conjugated diene. The propylene-based polymer backbone, for example, may comprise propylene, ethylene, and optionally 5-ethylidene-2-norbornene (ENB) or a linear α-omega diene.

In certain embodiments the polyolefin may have a level of isotacticity ranging from 50% to 99%.

The polyolefin polymer may comprise a component with branching index (g′) of from 0.7 to 0.98 measured at the Mz of the polyolefin when the polyolefin has an Mw of 10,000 to 60,000.

The presently disclosed copolymer comprises at least 85 mole %, preferably at least 90 mole % of units derived from propylene. Generally, the maximum concentration of propylene-derived units in the copolymer is 98 mole %, preferably 95 mole %, more preferably 90 mole % of the copolymer. In addition to propylene-derived units, the present copolymer contains from about 1 mole % to about 15 mole %, preferably from about 1 mole % to about 10 mole %, more preferably about 2 mole % to about 12 mole %, and most preferably about 2 mole % to about 10 mole of units derived from preferably at least one C4 to C10 alpha-olefin.

One, two or more comonomers can be copolymerized with propylene. Preferred comonomer may be derived from ethylene or α-olefins containing 4 to 12 carbon atoms. Exemplary α-olefins may be selected from the group consisting of ethylene; 1-butene; 1-pentene-2-methyl-1-pentene-3-methyl-1-butene; 1-hexene-3-methyl-1-pentene-4-methyl-1-pentene-3,3-dimethyl-1-butene; 1-heptene; 1-hexene; 1-methyl-1-hexene; dimethyl-1-pentene; trimethyl-1-butene; ethyl-1-pentene; 1-octene; methyl-1-pentene; dimethyl-1-hexene; trimethyl-1-pentene; ethyl-1-hexene; 1-methylethyl-1-pentene; 1-diethyl-1-butene; propyl-1-pentene; 1-decene; methyl-1-nonene; 1-nonene; dimethyl-1-octene; trimethyl-1-heptene; ethyl-1-octene; methylethyl-1-butene; diethyl-1-hexene; 1-dodecene and 1-hexadodecene.

Preferred C4 to C10 alpha-olefins are those having 6 to 8 carbon atoms, with the most preferred alpha-olefin being hexene-1.

In an embodiment, the copolymer can contain small amounts, generally less than 10 mole % or 5 mole % of units derived from other comonomers, such as ethylene, C4 and C5 alpha-olefins and C11 to C20 alpha-olefins, but preferably the copolymer consists essentially of units derived from propylene and one or more C4 to C10 alpha-olefins.

The present copolymer has a heat of fusion as determined by differential scanning calorimetry (DSC) between about 5 and 100 J/g, for example between about 5 and 60 J/g, between about 5 and 45 J/g, between about 5 and 30 J/g, between about 10 and about 35 J/g, between about 10 and about 30 J/g, between about 20 and about 40 J/g, or between about 20 and about 30 J/g. Heat of fusion is determined using Differential Scanning calorimetry measurement according to ASTM D3418-03.

The copolymer typically has a peak melting point (Tm) of less than about 150° C., less than about 120° C., less than about 100° C., less than about 90° C., or preferably less than about 85° C. Typically, the melting point may range from 50° C. to 90° C., from 50° C. to 85° C., from 60° C. to 85° C., from 65° C. to 80° C., or from 70° C. to 80° C. This melting point is due to crystallizable propylene sequences, preferably of isotactic polypropylene. The semi-crystalline copolymer has stereoregular propylene sequences which are long enough to crystallize. The length and distribution of stereoregular propylene sequences is consistent with the substantially random statistical copolymerization. It is well known that sequence length and distribution are related to the copolymerization reactivity ratios. By “substantially random”, we mean copolymer for which the product of the reactivity ratios is 2 or less. In stereoblock structures, the average length of polypropylene sequences is greater than that of substantially random copolymers with a similar composition. Prior art polymers with stereoblock structure have a distribution of polypropylene sequences consistent with these blocky structures rather than a random substantially statistical distribution. The reactivity ratios and sequence distribution of the polymer can be determined by C-13 NMR which locates the comonomer residues in relation to the neighboring propylene residues. This is according to the procedures described in the article by H. Kakugo, Y Naito, K. Mizunama and T. Miyatake in Macromolecules (1982), pages 1150-1152.

The weight averaged molecular weight (Mw) of the copolymer is preferably less than 250,000, more preferably less than 100,000 and typically less than 60,000. In general, the weight averaged molecular weight of the copolymer is at least 5,000, such as at least 10,000 or at least about 15,000. The copolymer may have a molecular weight distribution (MWD, Mw/Mn) within the range from 1.5 to 10, from 1.8 to 10, from 2 to 7, or preferably 1.8 to 5, more preferably from 1.8 to 4.0, 1.8 to 3.0, or 1.8 to 2.5 in certain embodiments. The MWD is the ratio of the weight-average molecular weight to the number-average molecular weight ratio (i.e. Mw/Mn).

Generally, the semi-crystalline copolymer has a viscosity of less than 50,000 mP·s (1 centipoise [cps]=1 mP·s), for example less than 25,000 mP·s, such as less than 10,000 mP·s, for example less than 5,000 mP·s measured at 190° C. using a Brookfield viscometer (as measured by ASTM D 3236 at 190° C.). Typically, the viscosity may range from 800 to 5000, from 2000 to 4000, from 2400 to 3600, or from 2800 to 3200. Melt Viscosity was determined according to ASTM D-3236, which is also referred to herein as “viscosity” and/or “Brookfield viscosity”.

In embodiments, the copolymer ratio of weight average molecular weight to viscosity (mPa·s) measured at 190° C. using a Brookfield viscometer (as measured by ASTM D 3236 at 190° C.) of from 10 to 20, preferably from 13 to 17, or more preferably from 14 to 16.

In embodiments, the copolymers as described here have a melt index in dg/min (“MI”), according to ASTM D-1238 at 2.16 kg and 190° C., 100 or more, preferably 500 or more, even more preferably 1000 or more. The MI may range from 1,000 to 4,500 dg/min, preferably 1,000 to 3,000 dg/min, more preferably 1,000 to 2,500 dg/min. Typically the MI may range from 1,000 to 2,000 dg/min, from 1,200 to 1,800 dg/min, or from 1,400 to 1,600 dg/min.

In embodiments, the polyolefin polymers as described here have a Melt Flow Rate in dg/min (“MFR”), according to ASTM D-1238 at 2.16 kg and 230°, of 10 dg/min or more, 100 dg/min or more, 1000 or more, preferably 2000 or more, even more preferably 3000 or more. The MFR may range from 3,000 to 16,000 dg/min, preferably 3,000 to 13,000 dg/min, more preferably 3,000 to 10,000 dg/min. Typically the MFR may range from 3,000 to 10,000 dg/min, from 3,000 to 7,500 dg/min, or from 4,000 to 6,000 dg/min.

In embodiments, the copolymer described above also has a Shore A Hardness (as measured by ASTM 2240) of 95 or more, 70 or more, or 60 or more, or 50 or more. In certain applications, the Shore A Hardness is preferably about 80 to about 100. In another embodiment, the polymer has a Shore A hardness of 85-95.

In embodiments, the copolymer described above also has a Shore C Hardness (as measured by ASTM 2240) of 95 or less, 90 or less, 85 or less, 80 or less, 70 or less, 60 or less, 50 or less, 40 or less, or 30 or less. In other embodiments the Shore A Hardness is 5 or more, 10 or more, or 15 or more, 20 or more, 30 or more, 40 or more, 50 or more, 60 or more. In certain applications, the Shore A Hardness is preferably about 30 to about 70, about 30 to about 40, about 40 to about 50, about 50 to about 60, about 60 to about 70, about 35 to about 65, or about 40 to about 50.

As discussed, in certain embodiments, the polypropylene(s) are isotactic. Isotacticity of the propylene sequences in the polypropylenes can be achieved by polymerization with the choice of a desirable catalyst composition. The isotacticity of the polypropylenes as measured by C-13 NMR, and expressed as meso diad content is greater than 85% (meso diads [m]>0.85) or 90% or 92% or 95% in certain embodiments as determined in U.S. Pat. No. 4,950,720 by C-13 NMR which is incorporated herein by reference. Expressed another way, the isotacticity of the polypropylenes as measured by C-13 NMR, and expressed as triad content (mm), is greater than 80% or 82% or 85% in certain embodiments.

The polyolefin can vary widely in composition. For example, substantially isotactic polypropylene homopolymer or propylene copolymer containing equal to or less than 15 mole % of other monomer, that is, at least 85 mole % by weight propylene can be used. The polypropylene may be a combination of homopolypropylene, and/or random, and/or block copolymers as described herein.

In another embodiment, the polymer may comprise a glass transition temperature (Tg) of 5° C. or less; preferably of 0° C. or less; or −10° C. or less; or −15° C. or less.

In some embodiments, the polypropylene copolymer described above also has a crystallization point (Tc) between 0° C. and 50° C. In some embodiments the Tc is between 5° C. to 40° C. In other embodiments the Tc is between 5° C. to 30° C. or between 5° C. to 20° C. or between 5 to 15° C. or between 5 to 10° C. In other embodiments, the Tc is below 10° C. In still other embodiments, the Tc may be at least 10° C. below the Tm, at least 20° C. below the Tm, at least 30° C. below the Tm, at least 40° C. below the Tm, at least 50° C. below the Tm, or at least 60° C. below the Tm.

The polypropylene copolymer may have a crystallinity of about 40% or less. Preferably, the polyolefin composition has a crystallinity of about 30% or less, alternatively about 20% or less. In some embodiments, the polyolefin composition has a crystallinity of from about 2% to about 40% or from about 5% to about 15%. Percent crystallinity content is determined using Differential Scanning calorimetry measurement according to ASTM D3418-03. The heat of fusion is dependent on the composition of the polypropylene; the thermal energy for the highest order of polyolefin is estimated at 208 J/g that is, 100% crystallinity is equal to a heat of fusion of 208 J/g. A polypropylene homopolymer will have a higher heat of fusion than a copolymer or blend of homopolymer and copolymer.

Advantageously, the propylene copolymer further has an intrinsic viscosity [q], measured at 135° C. in decalin, of usually from 0.1 to 5 dl/g, 0.1 to 2 dl/g, 0.1 to 1 dl/g, 0.1 to 0.8 dl/g, 0.1 to 0.5 dl/g, 0.2 to 0.4

In a preferred embodiment the copolymer comprises from 50 mole % propylene or greater and from 0.01 to 50 mole % butene, preferably from 0.01 to 30 mole % butene, more preferably from 0.01 to 15 mole % butene, more preferably from 0.01 to 10 mole % butene, more preferably from 0.01 to 5 mole % butene.

In a preferred embodiment the copolymer comprises 50 mole % propylene or greater and from 0.01 to 50 mole % hexene, preferably from 0.01 to 30 mole % hexene, more preferably from 0.01 to 15 mole % hexene, more preferably from 0.01 to 10 mole % hexene, more preferably from 0.01 to 5 mole % hexene.

### Methods of Making the Copolymer

The polyolefin copolymers may be prepared by any conventional synthesis processes. Preferably, polypropylene is prepared utilizing one or more catalysts, which are typically metallocene catalysts, by polymerization of an olefin monomer.

The propylene copolymers described herein may be produced in any known polymerization process. Polymerization methods include high pressure, slurry, gas, bulk, suspension, supercritical, or solution phase, or a combination thereof, preferably using a single-site metallocene catalyst system. The catalysts can be in the form of a homogeneous solution, supported, or a combination thereof. Polymerization may be carried out by a continuous, a semi-continuous or batch process and may include use of chain transfer agents, scavengers, or other such additives as deemed applicable. By continuous is meant a system that operates (or is intended to operate) without interruption or cessation. For example a continuous process to produce a polymer would be one where the reactants are continually introduced into one or more reactors and polymer product is continually withdrawn. In one embodiment, the propylene copolymer described herein is produced in a single or multiple polymerization zones using a single polymerization catalyst.

Single-site metallocene catalysts or catalyst systems are preferred. Suitable single site metallocene catalysts for use herein include those obeying the following general formula (I):

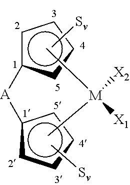

wherein:

M is a Group 3, 4, 5 or 6 transition metal atom, or a lanthanide metal atom, or actinide metal atom, preferably a Group 4 transition metal atom selected from titanium, zirconium or hafnium;

each cyclopentadienyl (Cp) ring is substituted with from zero to four substituent groups S, each substituent group S being, independently, a hydrocarbyl, substituted-hydrocarbyl, halocarbyl, substituted-halocarbyl, hydrocarbyl-substituted organometalloid, halocarbyl-substituted organometalloid, disubstituted boron, disubstituted pnictogen, substituted chalcogen or halogen radical, provided that two adjacent S groups may joined to form a C₄ to C₂₀ ring to give a saturated or unsaturated polycyclic ligand;

the subscript “v” denotes the carbon atom on the Cp-ring to which the substituent is bonded;

A is a bridging group; and

X₁ and X₂ are, independently, hydride radicals, hydrocarbyl radicals, substituted hydrocarbyl radicals, halocarbyl radicals, substituted halocarbyl radicals, and hydrocarbyl- and halocarbyl-substituted organometalloid radicals, substituted pnictogen radicals, or substituted chalcogen radicals; or X₁ and X₂ are joined and bound to the metal atom to form a metallacycle ring containing from about 3 to about 20 carbon atoms; or X₁ and X₂ together can be an olefin, diolefin or aryne ligand; or when Lewis-acid activators, such as methylalumoxane, which are capable of donating an X₁ ligand as described above to the transition metal component are used, X₁ and X₂ may independently be a halogen, alkoxide, aryloxide, amide, phosphide or other univalent anionic ligand or both X₁ and X₂ can also be joined to form a anionic chelating ligand and with the proviso that X₁ and X₂ are not a substituted or unsubstituted cyclopentadienyl ring.

Preferably, A is a bridging group containing boron or a Group 14, 15 or 16 element. Examples of suitable bridging groups include R′₂C, R′₂Si, R′₂Ge, R′₂CCR′₂, R′₂CCR′₂CR′₂, R′₂CCR′₂CR′₂CR′₂, R′C═CR′, R′C═CR′CR′₂, R′₂CCR′═CR′CR′₂, R′C═CR′CR′═CR′, R′C═CR′CR′₂CR′₂, R′₂CSiR′₂, R′₂SiSiR′₂, R′₂CSiR′₂CR′₂, R′₂SiCR′₂SiR′₂, R′C═CR′SiR′₂, R′₂CGeR′₂, R′₂GeGeR′₂, R′₂CGeR′₂CR′₂, R′₂GeCR′₂GeR′₂, R′₂SiGeR′₂, R′C═CR′GeR′₂, R′B, R′₂C—BR′, R′₂C—BR′—CR′₂, R′N, R′P, O, S, Se, R′₂C—O—CR′₂, R′₂CR′₂C—O—CR′₂CR′₂, R′₂C—O—CR′₂CR′₂, R′₂C—O—CR′—CR′, R′₂C—S—CR′₂, R′₂CR′₂C—S—CR′₂CR′₂, R′₂C—S—CR′₂CR′₂, R′₂C—S—CR′═CR′, R′₂C—Se—CR′₂, R′₂CR′₂C—Se—CR′₂CR′₂, R′₂C—Se—CR′₂CR′₂, R′₂C—Se—CR′═CR′, R′₂C—N═CR′, R′₂C—NR′—CR′₂, R′₂C—NR′—CR′₂CR′₂, R′₂C—NR′—CR′═CR′, R′₂CR′₂C—NR′—CR′₂CR′₂, R′₂C—P═CR′, and R′₂C—PR′—CR′₂ where R′ is hydrogen or a C₁-C₂₀ containing hydrocarbyl, substituted hydrocarbyl, halocarbyl, substituted halocarbyl, silylcarbyl or germylcarbyl substituent and optionally two or more adjacent R′ may join to form a substituted or unsubstituted, saturated, partially unsaturated or aromatic, cyclic or polycyclic substituent. Preferred examples for the bridging group Y include CH₂, CH₂CH₂, CH(CH₃)₂, O, S, SiMe₂, SiPh₂, SiMePh, Si(CH₂)₃ and Si(CH₂)₄.

The transition metal compounds described above are typically activated in various ways to yield compounds having a vacant coordination site that will coordinate, insert, and polymerize olefin(s). For the purposes of this patent specification and appended claims, the terms “cocatalyst” and “activator” are used herein interchangeably and are defined to be any compound which can activate any one of the catalyst compounds described above by converting the neutral catalyst compound to a catalytically active catalyst compound cation. Non-limiting activators, for example, include alumoxanes, aluminum alkyls, ionizing activators, which may be neutral or ionic, and conventional-type cocatalysts. Preferred activators typically include alumoxane compounds, modified alumoxane compounds, and ionizing anion precursor compounds that abstract one reactive, σ-bound, metal ligand making the metal complex cationic and providing a charge-balancing noncoordinating or weakly coordinating anion.

In addition to or in place of the alumoxane, the transition metal compounds described herein can be activated by an ionizing or stoichiometric activator, neutral or ionic, such as tri (n-butyl)ammonium tetrakis (pentafluorophenyl)boron, a trisperfluorophenyl boron metalloid precursor or a trisperfluoronaphtyl boron metalloid precursor, polyhalogenated heteroborane anions (WO 98/43983), boric acid (U.S. Pat. No. 5,942,459) or combination thereof.

Ionic stoichiometric activator compounds may contain an active proton, or some other cation associated with, but not coordinated to, or only loosely coordinated to, the remaining ion of the ionizing compound. Such compounds and the like are described in European publications EP-A-0 570 982; EP-A-0 520 732; EP-A-0 495 375; EP-B1-0 500 944; EP-A-0 277 003; and EP-A-0 277 004; and U.S. Pat. Nos. 5,153,157; 5,198,401; 5,066,741; 5,206,197; 5,241,025; 5,384,299; and 5,502,124; all of which are herein fully incorporated by reference. Ionic catalysts can be prepared by reacting a transition metal compound with a neutral Lewis acid, such as B(C₆F₆)₃, which upon reaction with the hydrolyzable ligand (X) of the transition metal compound forms an anion, such as ([B(C₆F₅)₃(X)]⁻), which stabilizes the cationic transition metal species generated by the reaction.

Compounds useful as an activator component in the preparation of the ionic catalyst systems used in the process of this invention comprise a cation, which is preferably a Bronsted acid capable of donating a proton, and a compatible non-coordinating anion which anion is relatively large (bulky), capable of stabilizing the active catalyst species (the Group 4 cation) which is formed when the two compounds are combined and said anion will be sufficiently labile to be displaced by olefinic diolefinic and acetylenically unsaturated substrates or other neutral Lewis bases such as ethers, nitriles and the like. Two classes of compatible non-coordinating anions have been disclosed in EPA 277,003 and EPA 277,004 published 1988: 1) anionic coordination complexes comprising a plurality of lipophilic radicals covalently coordinated to and shielding a central charge-bearing metal or metalloid core, and 2) anions comprising a plurality of boron atoms such as carboranes, metallacarboranes and boranes.

In a preferred embodiment, the stoichiometric activators include a cation and an anion component, and may be represented by the following formula:

(L-H)_{d}⁺(A^{d-})

wherein:

L is an neutral Lewis base;

H is hydrogen;

(L-H)⁺ is a Bronsted acid;

A^{d-} is a non-coordinating anion having the charge d−; and

d is an integer from 1 to 3.

The cation component, (L-H)_{d}⁺ may include Bronsted acids such as protons or protonated Lewis bases or reducible Lewis acids capable of protonating or abstracting a moiety, such as an alkyl or aryl, from the bulky ligand metallocene containing transition metal catalyst precursor, resulting in a cationic transition metal species.

The anion component A^{d-} include those having the formula [M^{k+}Qₙ]^{d-} wherein k is an integer from 1 to 3; n is an integer from 2-6; n−k=d; M is an element selected from Group 13 of the Periodic Table of the Elements, preferably boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Preferably, each Q is a fluorinated hydrocarbyl group having 1 to 20 carbon atoms, more preferably each Q is a fluorinated aryl group, and most preferably each Q is a pentafluoryl aryl group. Examples of suitable A^{d-} also include diboron compounds as disclosed in U.S. Pat. No. 5,447,895, which is fully incorporated herein by reference.

Illustrative, but not limiting examples of the ionic stoichiometric activator (L-H)_{d}⁺ (A^{d-}) is N,N-dimethylanilinium tetra(perfluorophenyl)borate, N,N-dimethylanilinium tetrakis(perfluoronapthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronapthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

The polymerization process employed to produce the presently disclosed copolymers can be conducted as a solution, bulk, gas or slurry polymerization process or a combination thereof, but preferably as a solution phase or bulk phase polymerization process.

The process may be carried out in a continuous stirred tank reactor, batch reactor or plug flow reactor, or more than one reactor operated in series or parallel. These reactors may have or may not have internal cooling or heating and the monomer feed may or may not be refrigerated. See the general disclosure of U.S. Pat. No. 5,001,205 for general process conditions. See also, International Patent Publication Nos. WO 96/33227 and WO 97/22639 which are incorporated herein by reference.

### Methods for Preparing Adhesive Compositions

Exemplary processes for preparing the adhesive composition comprise providing a metallocene catalyst polymerization derived copolymer of propylene and at least one monomer selected from C4 to C20 alpha-olefin, having a propylene content of at least 50 mole % and said copolymer having a heat of fusion of from 5 to 60 J/g providing at least one additive such as a tackifier. The copolymer and at least one additive are blended to form the adhesive composition. Optionally the adhesive is pelletized or drummed before it is shipped.

The adhesive or adhesive composition may be in the form of a concentrated masterbatch which requires dilution (“extension”) with a polyolefin or a resin before it can be applied to a substrate.

### Tackifiers

Tackifiers, i.e., hydrocarbon resins, include conventional tackifiers known to those skilled in the art. Exemplary tackifiers include, but are not limited to, aliphatic hydrocarbon resins, aromatic modified aliphatic hydrocarbon resins, hydrogenated polycyclopentadiene resins, polycyclopentadiene resins, gum rosins, gum rosin esters, wood rosins, wood rosin esters, tall oil rosins, tall oil rosin esters, polyterpenes, aromatic modified polyterpenes, terpene phenolics, aromatic modified hydrogenated polycyclopentadiene resins, hydrogenated aliphatic resin, hydrogenated aliphatic aromatic resins, hydrogenated terpenes and modified terpenes, and hydrogenated rosin esters. In some embodiments the tackifier is hydrogenated. In other embodiments the tackifier is non-polar. Non-polar means that the tackifier is substantially free of monomers having polar groups. Preferably the polar groups are not present, however if they are preferably they are not present at more that 5 wt %, preferably not more that 2 wt %, even more preferably no more than 0.5 wt %. In some embodiments the tackifier has a softening point (Ring and Ball, as measured by ASTM E-28) of 80° C. to 150° C., preferably 100° C. to 130° C.

The tackifier, if present, is typically present at about 1 wt % to about 20 wt %, based upon the weight of the blend, more preferably 2 wt % to 10 wt %, even more preferably 3 wt % to 10 wt %, based on the weight of the adhesive composition.

Exemplary tackifiers are commercially available as the ESCOREZ™ family, e.g., 5300, 5320, 5340, 5380, 5690, 5600, and 5620, or the Oppera™ series of polymeric additives from ExxonMobil Chemical Company.

### Waxes

The adhesive composition may comprise one or more additives including waxes. In this section we discuss these waxes in further detail. Waxes include natural or synthetic waxes, polypropylene waxes, and polyethylene waxes. Waxes include Fischer Tropsch waxes, available from Sasol Corporation or Bareco Corporation, polyethylene waxes, available from Baker Petrolite Corporation, Honeywell Corporation, or Eastman Corporation, or oxidized high density polyethylene homopolymer waxes, available from Honeywell Corporation.

In particular, waxes suitable for use in the invention include paraffin waxes, microcrystalline waxes, high density low molecular weight polyethylene waxes, by-product polyethylene waxes, oxidized Fischer Tropsch waxes and functionalized waxes such as hydroxyl stearamide waxes and fatty amide waxes. It is common in the art to use the terminology synthetic high melting point waxes to include high density low molecular weight polyethylene waxes, by-product polyethylene waxes and Fischer Tropsch waxes. Preferred waxes useful in the practice of the invention have a melting point of from about 60° C. to about 120° C. and will have an oil content of less than about 0.5 wt % based on the weight of the wax.

The wax may have a viscosity at 140° C. from about 100 mP·s and about 10,000 mP·s and at least one of (a)-(d): (a) mettler drop point as determined by ASTM-D3954-94 is greater than 110° C.; (b) a congealing point as determined by ASTM D-938 of greater than 110° C.; (c) a ring and ball softening point as determined by ASTM E-28 of greater than 110° C.; or (d) a peak melt temperature as determined by DSC of greater than 110° C.

### Functionalized Component

The adhesive composition may comprise one or more additives including functional components. In this section we discuss these functional components in further detail. Typically, the component to be functionalized is combined with a free radical initiator and a grafting monomer or other functional group (such as maleic acid or maleic anhydride) and is heated to react the monomer with the polymer, copolymer, oligomer, etc to form the functionalized component. Multiple methods exist in the art for functionalizing polymers that may be used with the polymers described here. These include selective oxidation, free radical grafting, ozonolysis, epoxidation, and the like.

Examples of suitable functionalized components for use in this invention include, but are not limited to, functionalized olefin polymers, (such as functionalized C2-C40 homopolymers, functionalized C2-C40 copolymers, functionalized higher Mw waxes), functionalized oligomers, (such as functionalized low Mw waxes, functionalized tackifiers), beta nucleating agents and combinations thereof.

Useful functionalized olefin polymers and copolymers useful in this invention include maleated polyethylene, maleated metallocene polyethylene, maleated metallocene polypropylene, maleated ethylene propylene rubber, maleated polypropylene, maleated ethylene copolymers, functionalized polyisobutylene (typically functionalized with maleic anhydride typically to form a succinic anhydride), and the like.

Preferred functionalized waxes useful as functionalized components herein include those modified with an alcohol, an acid, a ketone, an anhydride and the like. Preferred examples include waxes modified by methyl ketone, maleic anhydride or maleic acid. Preferred functionalized waxes useful herein include maleated polypropylene was available from Chusei under the tradename MAPP 40, maleated metallocene waxes (such as TP LICOCENE PP1602 available from Clariant, in Augsburg, Germany); maleated polyethylene waxes and maleted polypropylene waxes available from Eastman Chemical in Kingsport Tenn. under the trade names EPOLENE C-16, EPOLENE C-18, EPOLENE E43, EPOLENE G-3003; maleated polypropylene wax LICOMONT AR 504 availabe from Clariant; grafted functional polymers available from Dow Chemical Co., under the tradenames AMPLIFY EA 100, AMPLIFY EA 102, AMPLIFY 103, AMPLIFY GR 202, AMPLIFY GR 205, AMPLIFYGR 207, AMPLIFY GR 208, AMPLIFY GR 209, AMPLIFY VA 200; CERAMER maleated ethylene polymers available from Baker Hughes under the tradename CERAMER 1608, CERAMER 1251, CERAMER 67, CERAMER 24; and ethylene methyl acrylate co and terpolymers.

Useful waxes include polypropylene waxes having an Mw weight of 15,000 for less, preferably from 3000 to 10,000 and a crystallinity of 5% or more, preferably 10% or more having a functional group content (preferably maleic anhydride) of up to 10 weight %. Additional preferred functionalized polymers for use as functional components herein include A-C X596A, A-C X596P, A-C X597A, A-C X597P, A-C X950P, A-C X1221, A-C 395A, A-C 395A, A-C 1302P, A-C 540, A-C 54A, A-C 629, A-C 629A, and A-C 307, A-C 307A available from Honeywell.

UNILIN long chain alcohols, available from Baker Hughes are also useful as functionalized components herein, particularly UNILIN 350, UNILIN 425, UNILIN 550, and UNILIN 700.

UNICID linear, primary carboxylic acids, available from Baker Hughes are also useful as functionalized components herein, particularly UNICID 350, UNICID 425, UNICID 550, and UNICID 700.

Preferred functionalized hydrocarbon resins that may be used as functionalized components in this invention include those described in WO 03/025084; WO 03/025037; WO 03/025036; and EP 1 295 926 A1; which are incorporated by reference herein.

In a preferred embodiment a hydrocarbon resin is functionalized with an unsaturated acids or anhydrides containing at least one double bond and at least one carbonyl group and used as the functionalized component of this invention. Preferred hydrocarbon resins that can be functionalized are listed below as tackifiers. Representative acids include carboxylic acids, anhydrides, esters and their salts, both metallic and non-metallic. Preferably the organic compound contains an ethylenic unsaturation conjugated with a carbonyl group (—C═O). Examples include maleic, fumaric, acrylic, methacrylic, itaconic, crotonic, alpha.methyl crotonic, and cinnamic acids as well as their anhydrides, esters and salt derivatives. Particularly preferred functional groups include maleic acid and maleic anhydride. Maleic anhydride is particularly preferred. The unsaturated acid or anhydride is preferably present at about 0.1 wt % to about 10 wt %, preferably at about 0.5 wt % to about 7 wt %, even more preferably at about 1 to about 4 weight %, based upon the weight of the hydrocarbon resin and the unsaturated acid or anhydride. In a preferred embodiment the unsaturated acid or anhydried comprises a carboxylic acid or a derivative thereof selected from the group consisting of unsaturated carboxylic acids, unsaturated carboxylic acid derivatives selected from esters, imides, amides, anhydrides and cyclic acid anhydrides or mixtures thereof.

In some embodiments, the functionalized component is present at from 0.01 wt % to 5 weight %, preferably from 0.01 wt % to 4 wt %, preferably from 0.01 wt % to 3 weight %, preferably from 0.01 wt % to 2 wt %, preferably from 0.01 wt % to 1 wt %, preferably from 0.01 wt % to 0.5 weight % or less, preferably from 0.01 to 0.1 wt %, based upon the weight of the adhesive composition. In some preferred embodiments, the functionalized component is present in an amount of from 1 wt % to 5 wt %, from 1 wt % to 4 wt %, or from 2.0 wt % to 4.0 wt %. In some preferred embodiments, a functionalized component is not present in the adhesive.

### Other Additives

In addition to waxes, additives also include conventional additives known in the art, including fillers, antioxidants, adjuvants, adhesion promoters, plasticizers, oils, low molecular weight polymers, block, antiblock, pigments, processing aids, UV stabilizers, neutralizers, lubricants, surfactants nucleating agents, oxidized polyolefins, acid modified polyolefins, and/or anhydride modified polyolefins. Additives are combined with polymer compositions as individual components, in masterbatches, or combinations thereof.

Fillers include conventional fillers known to those skilled in the art, including titanium dioxide, calcium carbonate, barium sulfate, silica, silicon dioxide, carbon black, sand, glass beads, mineral aggregates, talc, and/or clay.

Antioxidants include conventional antioxidants known to those skilled in the art, including phenolic antioxidants, such as Irganox 1010, Irganox 1076 both available from Ciba-Geigy. In some embodiments adhesive compositions include less than about 3 wt % anti-oxidant.

Oils include conventional oils known to those skilled in the art, including paraffinic or napthenic oils such as Primol 352, or Primol 876 available from ExxonMobil Chemical France, S.A. in Paris, France. Preferred oils include aliphatic naphthenic oils.

Plasticizers include conventional plasticizers known to those skilled in the art, including mineral oils, phthalates, or polybutenes, such as Parapol 950 and Parapol 1300 formerly available from ExxonMobil Chemical Company in Houston Tex. Preferred plasticizers include phthalates such as di-iso-undecyl phthalate (DIUP), di-iso-nonylphthalate (DINP), and dioctylphthalates (DOP).

Adhesion promoters include conventional adhesion promoters known to those skilled in the art. Adhesion promoters include polar acids, polyaminoamides, such as Versamid 115, 125, 140, available from Henkel, urethanes, such as isocyanate/hydroxy terminated polyester systems, e.g., bonding agent TN/Mondur Cb-75 (Miles, Inc., coupling agents, such as silane esters (Z-6020 from Dow Corning), titanate esters, such as Kr-44 available from Kenrich, reactive acrylate monomers, such as sarbox SB-600 from Sartomer, metal acid salts, such as Saret 633 from Sartomer, and polyphenylene oxide.

Low number average molecular weight (Mₙ) polymers include conventional low Mₙ polymers known to those skilled in the art. Preferred low Mₙ polymers include polymers of lower alpha olefins such as propylene, butene, pentene, and hexene. A particularly preferred polymer includes polybutene having an Mₙ of less than 1000. An example of such a polymer is available under the trade name PARAPOL™ 950 from ExxonMobil Chemical Company. PARAPOL™ 950 is a liquid polybutene polymer having a Mn of 950 and a kinematic viscosity of 220 cSt at 100° C., as measured by ASTM D 445. In some embodiments polar and non-polar waxes are used together in the same composition.

Adhesive compositions are composed of less than about 30 wt % additives based on the total weight of the adhesive composition. Preferably, adhesive compositions include less than about 25 wt % additives, or less than about 20 wt % additives, or less than about 15 wt % additives, or less than about 10 wt % additives. In some embodiments, additives are present at less than about 5 wt %, or less than about 3 wt %, or less than about 1 wt %, based upon the weight of the adhesive composition. Exemplary adhesive compositions are commercially available from ExxonMobil Chemical Co. as the LINXAR™ adhesive family of products.

### Adhesive Properties

The provided adhesive compositions exhibit a high creep retention and a high storage modulus.

In one embodiment of the present invention, it is desired that the adhesive useful in the present invention exhibit a Storage Modulus value, at about 25° C., that is greater than about 5×10⁶ dynes per square centimeter, greater than about 6×10⁶ dynes per square centimeter, greater than about 7×10⁶ dynes per square centimeter, greater than about 8×10⁶ dynes per square centimeter, and up to about 1×10¹⁰ dynes per square centimeter.

In another embodiment of the present invention, it is desired that the adhesive exhibit a Storage Modulus value, across the temperature range of about 15° C. to about 40° C., that is greater than about 5×10⁶ dynes per square centimeter, greater than about 6×10⁶ dynes per square centimeter, greater than about 7×10⁶ dynes per square centimeter, greater than about 8×10⁶ dynes per square centimeter, and up to about 1×10¹⁰ dynes per square centimeter.

In it also desired that the adhesive exhibit a tan delta at 25° C. of from 0.2 to 0.8, 0.2 to 0.6, 0.2 to 0.5, and 0.3 to 0.5.

In some embodiments the adhesive composition described above has a viscosity (also referred to a Brookfield Viscosity or Melt Viscosity) of 10,000 mP·s or less at 190° C. (as measured by ASTM D 3236 at 190° C.); or 8,000 mP·s or less, or 7,000 mP·s or less, or 6,000 mP·s or less, or 5,000 mP·s or less, or 4,000 mP·s or less, or between 250 and 5000 mP·s, or between 500 and 5000 mP·s, or between 1000 and 5000 mP·s, or between 1500 and 5000 mP·s, or between 1500 and 4500, or between 2000 and 4500, or between 2500 and 4500, or between 3000 and 4000 mPa·s.

In embodiments, the adhesive composition described above also has a Shore A Hardness (as measured by ASTM 2240) of 95 or more, 70 or more, or 60 or more, or 50 or more. In certain applications, the adhesive composition has a Shore A Hardness of about 70 to about 90 or about 75 to about 85.

In embodiments, the adhesive composition described above also has a Shore C Hardness (as measured by ASTM 2240) of 95 or less, 90 or less, 85 or less, 80 or less, 70 or less, 60 or less, 50 or less, 40 or less, or 30 or less. In other embodiments, the Shore A Hardness is 5 or more, 10 or more, or 15 or more, 20 or more, 30 or more, 40 or more, 50 or more, 60 or more. In certain applications, the adhesive composition has a Shore A Hardness of about 30 to about 55, about 30 to about 40, about 40 to about 55, about 35 to about 50, or about 40 to about 50.

The elastic attachment performance is typically measured by creep retention. For good performance the creep retention should be more than 60%, preferably more than 70%, more preferably more than 75%, most preferably more than 80% when the creep test is performed within 2 days after adhesive has been applied on substrates (initial creep test), or more than 50%, preferably more than 60%, most preferably more than 70%, when it is done after a storage time of two weeks at 54° C. (one-week-aged creep test). These conditions are indicative of the level of adhesion and bond retention under creep conditions that can be achieved.

The creep test was performed by cutting a specimen to 25 mm wide×400 mm fully elongated long (This assumes one spray nozzle used to generate elastic laminate with ˜12-20 mm width). The test direction is the machine direction (i.e. the elastic strand direction). The laminates are pre-conditioned in a relaxed state (usually in bundles slabbed off coater per condition) for 1 day at room temperature. The elastic specimen is then mounted in a stretched state at 95% elongation on rigid piece of cardboard. (Mark 300 mm, then relax to 285 mm and mount). Cut the elastic strands with a knife through the non-woven layer. Incubate the test board in 100′ F (38′ C) oven for 4 hours. Measure & record the average position of three cut strand ends. Calculate % Creep and % Creep Retention by the following formulas: % Creep=[(Initial Length−Final Length)/Initial Length*100] and % Creep Retention=[100%−% Creep].

### End Uses

Adhesives compositions are used in general adhesive applications and specialty applications, including but not limited to, disposables, packaging, laminates, pressure sensitive adhesives, tapes labels, wood binding, paper binding, non-wovens, road marking, reflective coatings, and the like.

The adhesive compositions are used for disposable diaper and napkin chassis construction, elastic attachment in disposable goods, converting, packaging, labeling, bookbinding, woodworking, and other assembly applications. Particularly preferred applications include: baby diaper leg elastic; diaper frontal tape; diaper standing leg cuff; diaper chassis construction; diaper core stabilization; diaper liquid transfer layer; diaper outer cover lamination; diaper elastic cuff lamination; feminine napkin core stabilization; feminine napkin adhesive strip; industrial filtration bonding; industrial filter material lamination; filter mask lamination; surgical gown lamination; surgical drape lamination; and perishable products packaging.

Adhesive compositions may be applied directly to a substrate or may be sprayed thereon. Spraying is defined to include atomizing, such as producing an even dot pattern, spiral spraying, or melt blown techniques. In general, melt blown techniques are processes that use air to spin hot melt adhesive fibers and convey them onto a substrate for bonding. Fiber sizes can easily be controlled from 20-200 microns by changing the melt to air ratio.

The adhesives described above may be applied to any substrate. Preferred substrates include wood, paper, cardboard, plastic, thermoplastic, rubber, metal, metal foil (such as aluminum foil and tin foil), metallized surfaces, cloth, non-wovens (particularly polypropylene spunbonded fibers or non-wovens), spunbonded fibers, cardboard, stone, plaster, glass (including silicon oxide (SiOx) coatings applied by evaporating silicon oxide onto a film surface), foam, rock, ceramics, films, polymer foams (such as polyurethane foam), substrates coated with inks, dyes, pigments, PVDC and the like or combinations thereof.

Additional preferred substrates include polyethylene, polypropylene, polyacrylates, acrylics, polyethylene terephthalate, or any of the polymers listed above as suitable for blends.

Any of the above substrates, and/or compositions, may be corona discharge treated, flame treated, electron beam irradiated, gamma irradiated, microwaved, or silanized.

### Experimental Methods

The following experimental procedures were used to measure the parameters which are disclosed in this specification.

Adhesive melt viscosity was measured using a Brookfield digital viscometer according to ASTM D-3236.

Molecular weights number average molecular weight (Mn), weight average molecular weight (Mw), and z-average molecular weight (Mz)) were determined using a Polymer Laboratories Model 220 high temperature SEC with on-line differential refractive index (DRI), light scattering, and viscometer detectors. It used three Polymer Laboratories PLgel 10 m Mixed-B columns for separation, a flow rate of 0.54 cm³/min, and a nominal injection volume of 300 μL. The detectors and columns are contained in an oven maintained at 135° C. The light scattering detector is a high temperature miniDAWN (Wyatt Technology, Inc.). The primary components are an optical flow cell, a 30 mW, 690 nm laser diode light source, and an array of three photodiodes placed at collection angles of 45°, 90°, and 135°. The stream emerging from the SEC columns is directed into the miniDAWN optical flow cell and then into the DRI detector. The DRI detector is an integral part of the Polymer Laboratories SEC. The viscometer is a high temperature viscometer purchased from Viscotek Corporation and comprising four capillaries arranged in a Wheatstone bridge configuration with two pressure transducers. One transducer measures the total pressure drop across the detector, and the other, positioned between the two sides of the bridge, measures a differential pressure. The viscometer is inside the SEC oven, positioned after the DRI detector. The details of these detectors as well as their calibrations have been described by, for example, T. Sun, P. Brant, R. R. Chance, and W. W. Graessley, in Macromolecules, Volume 34, Number 19, 6812-6820, (2001), incorporated herein by reference.

Solvent for the SEC experiment was prepared by adding 6 grams of butylated hydroxy toluene (BHT) as an antioxidant to a 4 liter bottle of 1,2,4 trichlorobenzene (TCB) (Aldrich Reagent grade) and waiting for the BHT to solubilize. The TCB mixture was then filtered through a 0.7 micron glass pre-filter and subsequently through a 0.1 micron Teflon filter. There was an additional online 0.7 micron glass pre-filter/0.22 micron Teflon filter assembly between the high pressure pump and SEC columns. The TCB was then degassed with an online degasser (Phenomenex, Model DG-4000) before entering the SEC. Polymer solutions were prepared by placing dry polymer in a glass container, adding the desired amount of TCB, then heating the mixture at 160° C. with continuous agitation for about 2 hours. All quantities were measured gravimetrically. The TCB densities used to express the polymer concentration in mass/volume units were 1.463 g/ml at room temperature and 1.324 g/ml at 135° C. The injection concentration ranged from 1.0 to 2.0 mg/ml, with lower concentrations being used for higher molecular weight samples.

The branching index (g′) was measured using SEC with an on-line viscometer (SEC-VIS) and is reported as g′ at each molecular weight in the SEC trace. The branching index g′ is defined as:

$${g}^{′} = \frac{{η}_{b}}{{η}_{l}}$$

where η_{b} is the intrinsic viscosity of the branched polymer and η₁ is the intrinsic viscosity of a linear polymer of the same viscosity-averaged molecular weight (Mᵥ) as the branched polymer. η₁=KMᵥ^{α}, K and α were measured values for linear polymers and should be obtained on the same SEC-DRI-LS-VIS instrument as the one used for branching index measurement. For polypropylene samples presented in this invention, K=0.0002288 and α=0.705 were used. Linear polymers selected as standards for comparison should be of the same viscosity average molecular weight, monomer content and composition distribution. Linear character for polymer containing C₂ to C₁₀ monomers is confirmed by Carbon-13 NMR using the method of Randall (Rev. Macromol. Chem. Phys., C29 (2&3), p. 285-297). Linear character for C11 and above monomers is confirmed by GPC analysis using a MALLS detector. For example, for a copolymer of propylene, the NMR should not indicate branching greater than that of the co-monomer (i.e. if the comonomer is butene, branches of greater than two carbons should not be present). For a homopolymer of propylene, the GPC should not show branches of more than one carbon atom. When a linear standard is desired for a polymer where the comonomer is C₉ or more, one can refer to T. Sun, P. Brant, R. R. Chance, and W. W. Graessley, Macromolecules, Volume 34, Number 19, 6812-6820, (2001) for protocols on determining standards for those polymers (incorporated herein by reference). In the case of syndiotactic polymers, the standard should have a comparable amount of syndiotacticity as measured by Carbon 13 NMR. The viscosity averaged g′ was calculated using the following equation:

$${g}_{vis}^{′} = \frac{\sum {{c}_{i} [ {η}_{i} ]}_{b}}{\sum {c}_{i} {KM}_{i}^{α}}$$

where cᵢ is the polymer concentration in the slice i in the polymer peak, and [ηᵢ]_{b} is the viscosity of the branched polymer in slice i of the polymer peak, and Mᵢ is the weight averaged molecular weight in slice i of the polymer peak measured by light scattering, K and α are as defined above.

Melting point (Tm), peak crystallization temperature (Tc), glass transition temperature (Tg), and heat of fusion (Hf) and percent crystallinity were determined by differential scanning calorimetry (DSC) by the following procedure according to ASTM D3418-03 using a TA Instruments model Q100 or Q200. Samples weighing approximately 5-10 mg are sealed in aluminum hermetic sample pans. The DSC data were recorded by first gradually heating the sample to 200° C. at a rate of 10° C./minute. The sample was kept at 200° C. for 2 minutes, and then cooled to −90° C. at a rate of 10° C./minute, followed by an isothermal for 2 minutes and heating to 200° C. at 10° C./minute. Both the first and second cycle thermal events are recorded. Tc, Tm, and Hf are measured on the second melt. Areas under the melting peaks are measured and used to determine the heat of fusion and the degree of crystallinity. The percent crystallinity (X %) is calculated using the formula, X %=[area under the curve (Joules/gram)/B (Joules/gram)]*100, where B is the heat of fusion for the homopolymer of the major monomer component. These values for B are to be obtained from the Polymer Handbook, Fourth Edition, published by John Wiley and Sons, New York 1999. A value of 208 J/g (B) is used as the heat of fusion for 100% crystalline polypropylene. The amorphous content (%) is calculated using the formula (100−percent of crystallinity). The melting point, glass transition temperature, heat of fusion, and crystallization temperature are measured and reported during the second heating cycle (or second melt).

For polymers displaying multiple endothermic and exothermic peaks, all the peak crystallization temperatures and peak melting temperatures were reported. The heat of fusion for each endothermic peak was calculated individually. The percent crystallinity is calculated using the sum of heat of fusions from all endothermic peaks. Some of polymer blends produced show a secondary melting/cooling peak overlapping with the principal peak, which peaks are considered together as a single melting/cooling peak. The highest of these peaks is considered the peak melting temperature/crystallization point. For the amorphous polymers, having comparatively low levels of crystallinity, the melting temperature is typically measured and reported during the first heating cycle. Prior to the DSC measurement, the sample was aged (typically by holding it at ambient temperature for a period up to about 2 days) or annealed to maximize the level of crystallinity.

The rheological properties (G′, G″) were determined on ARES instrument manufactured by Rheometric Scientific, Piscataway, N.J. The polymers were first melted and then cooled down at 1° C./min. Dynamic moduli were recorded during the cooling, starting from a temperature higher than the melting point of the material by at least 30° C. down to about 80° C. The output of the test is therefore the evolution of the storage modulus G′, the loss modulus G″, as well as the ratio tan delta(δ)=G″/G′ as a function of temperature. Measurements were made at a constant frequency of 10 rad/s and 20 percent of strain, using a 12.5 mm diameter plate-and-plate geometry.

Percent TREF extractables was determined during TREF (Temperature Rising Elution Fractionation) and represents an alternate method to quantify the generally low molecular weight, high comonomer-containing species that are prone to be migratory and extractable. In the TREF experiment [Exxon method, see Wild et al, Journal of Polymer Science, Polymer Physics Edition, vol 20, 441, (1982), U.S. Pat. No. 5,008,204, and WO 93/03093] these species are the ones that do not crystallize at 0° C., but remain in the solvent at this temperature.

Techniques for determining the molecular weight (Mn and Mw) and molecular weight distribution (MWD) are found in U.S. Pat. No. 4,540,753 (Cozewith, Ju and Verstrate) (which is incorporated by reference herein for purposes of U.S. practices) and references cited therein and in Macromolecules, 1988, volume 21, p 3360 (Verstrate et al).

### EXAMPLES

The invention will now be illustrated with reference to the following Examples. The Examples, which are not intended to be limiting, present certain embodiments and advantages of the hot melt adhesive compositions of the invention. Unless otherwise indicated, any percentages are on a weight basis, based on the total weight of the adhesive composition.

The following materials were used in examples identified in the following table.

TABLE 1
Properties of Polypropylene Copolymer

| | Wt % | | | | Viscosity | g′ @ | | | Hf |
|---|---|---|---|---|---|---|---|---|---|
| | Hexene | Mn | Mw | Mz | 190° C., (cps) | Mz | Tc (° C.) | Tm (° C.) | (J/g) |
| POA-1 | 13.6 | 20,944 | 43,012 | 73,378 | 2290 | 0.885 | 8.8 | 73.1 | 22.7 |
| POA-2 | 12.6 | 27,088 | 50,480 | | 3145 | | 9.5 | 74.9 | 20.0 |
| POA-3 | 13.5 | | | | 3,030 | | 10.5 | 70.9 | 29.5 |
| POA-4 | 13.5 | 20,903 | 49,960 | 90,260 | | 0.851 | | | |
| POA-5 | 11.5 | 18,301 | 47,229 | 84,392 | | 0.855 | | | |

TABLE 2
NMR Data (tacticity based on mole %)

| | mm | mr | rr | m | r |
|---|---|---|---|---|---|
| POA-1 | 84 | 11 | 5 | 90 | 10 |
| POA-2 | 86 | 10 | 4 | 88 | 12 |

TABLE 3
Details of compositions used in Samples

| SAMPLE | DESCRIPTION | SOURCE |
|---|---|---|
| A | Adhesive composition comprising (i) 82 wt % POA-1; (ii) 15 wt | ExxonMobil |
| | % tackifying resin; (iii) 3 wt % MAPP; and (iv) 1 wt % | |
| | stabilizer | |
| B | Adhesive composition comprising (i) 82 wt % POA-2; (ii) 15 wt | ExxonMobil |
| | % tackifying resin; (iii) 3 wt % MAPP; and (iv) 1 wt % | |
| | stabilizer | |
| C | Adhesive composition comprising (i) 82 wt % POA-3; (ii) 15 wt | ExxonMobil |
| | % tackifying resin; (iii) 3 wt % MAPP; and (iv) 1 wt % | |
| | stabilizer | |
| D | Adhesive composition comprising (i) 82 wt % POA-4; (ii) 15 wt | ExxonMobil |
| | % tackifying resin; (iii) 3 wt % MAPP; and (iv) 1 wt % | |
| | stabilizer | |
| E | Adhesive composition comprising (i) 82 wt % POA-5; (ii) 15 wt | ExxonMobil |
| | % tackifying resin; (iii) 3 wt % MAPP; and (iv) 1 wt % | |
| | stabilizer | |
| Stabilizer | Phenolic antioxidant | Ciba-Geigy |
| MAPP | Maleated polypropylene (MAPP) with acid value of 45~50, | Honeywell |
| | viscosity at 190° C. of 400-425 mPa·s, and softening point | |
| | of 143~155° C. | |
| HCR | Hydrogenated aromatic modified resin produced from | ExxonMobil |
| | dicyclopentadiene feedstock, exhibiting a ring and ball | |
| | softening point of 130° C. available from ExxonMobil as | |
| | Escorez ™ in Houston, Texas. | |

### Example

Samples of the adhesive composition were prepared by blending the various propylene copolymers with a tackying resin, a maleated polypropylene, and a phenolic antioxidant stabilizer.

Each of the Samples A-E comprise (i) a propylene-hexene copolymer having a weight average molecular weight of from 35,000 to 60,000 and a propylene content of approximately 90 wt % and hexene content of approximately 10 wt %; (ii) from 4 to 6 wt % FTF Wax; and (iii) from 2 to 4 wt % MAPP. Table 3 below illustrates creep retention at an open time of 0.4 seconds.

TABLE 4
Creep Retention

| | Air | Melt | Add-on Rate | Creep |
|---|---|---|---|---|
| | Temp | Temp | (mg/linear | Retention |
| Sample | (° C.) | (° C.) | meter/strand) | % |
| A | 150 | 150 | 50 | 92 |
| B | 150 | 150 | 50 | 91 |

There is thus provided an adhesive composition which has improved overall adhesive properties including advantageous creep retention and Storage modulus.

The above description is intended to be illustrative, and should not be considered limiting. Persons skilled in the art will recognize that various modifications may be made without departing from the spirit and scope of the invention. Accordingly, this description will be deemed to include all such modifications that fall within the appended claims and their equivalents. Certain features of the present invention are described in terms of a set of numerical upper limits and a set of numerical lower limits. It should be appreciated that ranges from any lower limit to any upper limit are within the scope of the invention unless otherwise indicated.

What is claimed is:

1. An adhesive composition comprising:
a polypropylene copolymer comprising at least 85 mole % of units derived from propylene and from about 1 to about 15 mole % of units derived from at least one C₄ to C₁₀ alpha-olefin wherein the polypropylene copolymer has:
(a) a heat of fusion from 5 to 60 J/g;
(b) a weight-average molecular weight (Mw) from 5,000 to 60,000;
(c) a weight-average molecular weight to number-average molecular weight ratio (Mw/Mn) from about 1.8 to 10;
(d) a melt index of greater than about 500 as measured by ASTM D1238(B);
(e) a melt temperature (Tm) of less than about 90° C. as measured by ASTM D3418-03;
(f) a crystallization temperature (Tc), as measured by ASTM D3418-03, of from about 5 to 20° C.; and
(ii) at least one tackifier.

2. The adhesive composition of claim 1, wherein the polypropylene copolymer has a ratio of weight-average molecular weight to apparent viscosity ratio of from about 10 to about 20 wherein the apparent viscosity is measured in centipoises.

3. The adhesive composition of claim 1, wherein the polypropylene copolymer satisfies the following formula:
Tm≧Tc+40
wherein Tc is the crystallization temperature and the Tm is the melting point of the composition each measured through differential scanning calorimetry.

4. The adhesive composition of claim 1, wherein the polypropylene copolymer has a melt index (MI) greater than 1000 dg/min as measured by ASTM D1238(B).

5. The adhesive composition of claim 1, wherein the polypropylene copolymer satisfies the following formula:
Tm≧Tc+50
wherein Tc is the crystallization temperature and the Tm is the melting point of the composition each measured through differential scanning calorimetry.

6. The adhesive composition of claim 1, wherein the polypropylene copolymer satisfies the following formula:
Tm≧Tc+60
wherein Tc is the crystallization temperature and the Tm is the melting point of the composition each measured through differential scanning calorimetry.

7. The composition of claim 1, wherein the polypropylene copolymer has a melt index (MI) greater than 1000 dg/min as measured by ASTM D1238(B).

8. The adhesive composition of claim 1, wherein the polypropylene copolymer has a weight average molecular weight of 35,000 to 60,000, a branching index (g′) of from 0.7 to 0.98 measured at the z-average molecular weight (Mz) of the polypropylene copolymer when the polypropylene copolymer has an weight average molecular weight of 35,000 to 60,000.

9. The adhesive composition of claim 1, wherein the polypropylene copolymer has a weight average molecular weight of 35,000 to 60,000, a branching index (g′) of from 0.7 to 0.9 measured at the z-average molecular weight (Mz) of the polypropylene copolymer when the polypropylene copolymer has an weight average molecular weight of 35,000 to 60,000.

10. The adhesive composition of claim 1, wherein the polypropylene copolymer has a weight average molecular weight of 35,000 to 60,000, a branching index (g′) of from 0.8 to 0.9 measured at the z-average molecular weight (Mz) of the polypropylene copolymer when the polypropylene copolymer has an weight average molecular weight of 35,000 to 60,000.

11. The adhesive composition of claim 1, wherein the polypropylene copolymer comprises at least 90 mole % of units derived from propylene and from about 1 mole % to about 10 mole % of units derived from at least one C4 to C10 alpha-olefin.

12. The adhesive composition of claim 1, wherein the polypropylene copolymer has a melt temperature of about 60 to 85° C.

13. The adhesive composition of claim 1, further comprising a functionalized component of from 0.01 to 5 wt % based on the adhesive composition.

14. The adhesive composition of claim 7, wherein the functionalized component is a functionalized polypropylene.

15. The adhesive composition of claim 7, wherein the functionalized component is a maleated polypropylene.

16. The adhesive composition of claim 1, having a Temperature Rising Elution Fractionation (TREF) soluble fraction of 60 to 90%.

17. The adhesive composition of claim 1, wherein the adhesive has a storage modulus at about 25° C., that is greater than about 5×10⁶ dynes per square centimeter.

18. The adhesive composition of claim 1, wherein the polypropylene copolymer has meso diad content is greater than 85%.

19. The adhesive composition of claim 1, wherein the polypropylene copolymer triad content (mm) is greater than 80%.

20. The adhesive composition of claim 1, wherein the tackifier comprises at least one hydrogenated polycyclopentadiene resin.

21. The adhesive composition of claim 1, wherein the tackifier is present at about 1 wt % to about 20 wt % based on the weight of the adhesive composition.

22. The adhesive composition of claim 1, wherein the polypropylene copolymer has a Shore A hardness of about 80 to about 100 as measured by ASTM 2240.

23. The adhesive composition of claim 1, wherein the adhesive composition has a Shore A hardness of about 70 to about 90 as measured by ASTM 2240.
